(19) United States
(12) Patent Application Publication
(10) Pub. No.: US 2022/0212838 A1
(43) Pub. Date: Jul. 7, 2022

(54) Fibrous Lid With High Polymer Mating Region

(71) Applicant: Robert D. Fish, Irvine, CA (US)

(72) Inventor: Robert D. Fish, Irvine, CA (US)

(21) Appl. No.: 17/613,378

(22) PCT Filed: May 19, 2020
(86) PCT No.: PCT/US20/33643

§ 371 Date: Nov. 22, 2021

Related U.S. Application Data
(63) Continuation of application No. 16/694,795, filed on Nov. 25, 2019, now abandoned.
(60) Provisional application No. 62/850,312, filed on May 20, 2019.

(30) Foreign Application Priority Data
Jun. 4, 2019 (EP) 1907921.9

(51) Int. Cl. B65D 43/02

(52) U.S. Cl. CPC B65D 43/0212; B65D 2543/00046; B65D 2543/00092; B65D 2543/00296; B65D 2543/00314; B65D 2543/00527; B65D 2543/00537; B65D 2543/00629; B65D 2543/00685; B65D 2543/00731; B65D 2543/00796

(57) ABSTRACT

A lid having body and side, each of which comprises a fibrous material. The side is configured to mate with a container having an upper rim bead, and wherein the side has a higher weight percentage of a polymer than the body. The higher weight percentage in the side can be present as an extra thick coating, and/or an extra layer of polymer relative to the body. The body and side can comprise the same or different fibrous materials, and independently can comprise the same of different polymers. The side of the lid preferably has at least 20 wt %, more preferably at least 40 wt %, and most preferably at least 60 wt % of fibrous material in their respective sides.

### PRIORITY CLAIM

This application claims priority to international application no. PCT/US2020/033643 filed May 19, 2020, U.S. provisional application Ser. No. 62/850,312 filed May 20, 2019, GB1907921.9 filed Jun. 4, 2019 and issued as GB2584640, and U.S. Utility application Ser. No. 16/694,795, filed Nov. 25, 2019, the disclosures of each of which are incorporated herein by reference.

### FIELD OF THE INVENTION

The field of the invention is lids for drinking cups.

### BACKGROUND

The following description includes information that may be useful in understanding the present invention. It is not an admission that any of the information provided herein is prior art or relevant to the presently claimed invention, or that any publication specifically or implicitly referenced is prior art.

Many people enjoy having coffee, tea, or other beverages, and it is well known to imbibe such drinks from a disposable paper cup. Such cups are typically constructed from paper having a thin inner plastic coating. One example is shown in U.S. Pat. No. 6,926,197. Such cups can also be made entirely of plastic, but paper is more environmentally friendly than plastic.

The U.S. Pat. No. 6,926,197 patent, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Paper-based cups have several disadvantages. For example, paper tends to absorb liquid, resulting in deformation of the cup. Wax-coated paper cups are advantageous in that they tend to resist deformation, however, their popularity diminished because wax can melt with hot liquids, and wax coatings tend to be too thick.

It is well known to make paper coffee cups with very thin plastic coatings. For example, US20070170236A1 teaches a cup made of a plastic-coated paper. Such cups provide several advantages. First, the plastic does not melt. Second, the plastic protects paper-based cups from liquid exposure.

Regarding lids, it is known in some instances to use a paper lid for a paper container. For example, U.S. Pat. No. 1,952,401 teaches a paper lid for an ice cream container. This paper lid is satisfactory for its intended purpose, but would not work well for a paper coffee cup because it provides an inadequate seal. A lid for the coffee cup must be closed tightly to provide a secure seal, because liquid would press against the lid when a person tilts the cup for drinking. A paper lid for an ice cream container works sufficiently well because one does not normally tilt the ice cream container with its lid attached. And also ice cream is solid, not liquid. A second reason that a paper lid is dysfunctional for a coffee cup is that as the lid absorbs liquid, even to a small extent, such absorption might well weaken the lid sufficiently to negatively impact the seal. For these and probably other reasons, the vast majority of lids for paper drinking cups are made entirely of plastic.

U.S. Pat. No. 4,589,569 teaches a plastic lid. Such lids work well with typical paper drinking cups, but are unsatisfactory with respect to environmental effects. Plastic pollution is currently one of the greatest environmental concerns, harming all manner of plants, oceans, animals, and humans. It can take hundreds or even thousands of years for plastic to break down, so the damage to the environment is long-lasting. It has been reported that about 16 billion plastic lids are used on disposable coffee cups each year. The European Union is moving forward on banning single-use plastic stirrers and plates by 2021. It is time for us to seriously consider how to reduce the amount of single-use plastic and maintain our environment clean and safe.

Recognizing that paper or mostly paper lids provide inadequate seals, Japanese patent application JPH09301394A and Korean patent application KR20070025299A each teach lids for drinking cups that have paper or mostly paper tops, and entirely plastic sides. Although adequate to reduce the amount of plastic in the lids, those designs introduce significant additional costs and complexity to mate the paper tops with the plastic sides, and even so fail to adequately reduce the amount of plastic utilized.

The basic problem is that “the perfect is the enemy of the good”. People keep trying to make a lid that is entirely fibrous material, i.e., with no plastic whatsoever. That may happen in the future, but in the meantime an awful lot of plastic is thrown away in plastic lids. What is needed right now is a lid made mostly of paper or other fiber-based material, but has sufficient plastic to provide an adequate seal for a coffee cup or other paper (or mostly paper) container.

### SUMMARY OF THE INVENTION

The inventive subject matter provides apparatus, systems, and methods in which a lid is made mostly of paper or other fiber-based material, both in the body and side portions, both potentially having a polymer coating, but with an extra coating or layer of polymer about the side portion to provide an improved seal.

As used herein, the side portion of the lid refers to that part of the lid which descends from the body of the lid, and which is sized and dimensioned to mate with an upper rim bead of a cup. The side portion preferably has an annular indentation or bump, with a depth or protrusion of at least 0.5 mm, more preferably at least 1.0 mm, and most preferably at least 1.5 mm. The side portion is preferably flared to assist a user in positioning the lid onto the top upper rim bead of a cup.

Preferred lids contain no more than 10 wt % of polymer material, more preferably no more than 5 wt % polymer, and still more preferably no more than 1 wt % polymer.

As technical improvements, the extra coating or layer of polymer about the mating portion provides additional stiffness, and in some cases additional fluid resistance, to the lid, all while reducing the total polymer percentage used in the lid. The extra coating or layer of polymer is at least 0.1 mm thick, more preferably at least 0.2 mm thick, and most preferably at least 0.3 mm thick. The extra coating or layer of polymer can be positioned medially, laterally, in a sandwich manner, or in any combination thereof, relative to the paper or other fibrous material contained in the mating portion.

Contemplated polymer materials include polyethylene, polydiketoenamine, polypropylene, polyethylene terephthalate, high-density polyethylene, polyvinyl chloride, low-density polyethylene, ultra-high-molecular-weight polyethylene, and any combination thereof. In some embodiments, the polymer is a natural polymer (e.g., cellulose), a biodegradable polymer, or a compostable polymer, and is preferably water resistant or water impermeable. In some embodiments, the polymer is heat resistant up to 100° C.

Preferred lids have a drinking hole disposed in a raised portion of the body, towards its radial edge, and in some cases a separate air hole. A polymer coating is preferably disposed on an upper surface of the body, either about its entire upper surface, or at least about least 5 mm about the drinking hole. Preferred lids also have a polymer coating disposed about the entire underside or interior surface of the body, or at least 90%, 80%, 70%, 60%, 50%, 40%, or 30% of the underside or interior surface, preferably extending from the radial edges inward toward the center of the body, or extending from the radial edge proximal to the drinking hole and extending toward the opposite radial edge of the body.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of a lid.

FIG. 2 is a vertical cross-sectional view of the lid of FIG. 1, and also showing a cup with which the lid is configured to mate.

FIG. 3 is a vertical cross-sectional view of an alternative embodiment of a lid.

FIG. 4 is a vertical cross-sectional view of another alternative embodiment of a lid.

FIG. 5 is a vertical cross-sectional view of another alternative embodiment of a lid.

FIG. 6 is a vertical cross-sectional view of another alternative embodiment of a lid.

FIG. 7 is a vertical cross-sectional view of yet another alternative embodiment of a lid.

FIG. 8 is a vertical cross-sectional view of still another alternative embodiment of a lid.

FIG. 9 is a ventral view of another alternative embodiment of a lid.

FIG. 10 is a ventral view of yet another alternative embodiment of a lid.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The present invention relates to apparatus, methods, and systems for a lid having paper or other fiber-containing material in both (a) its body and (b) its descending side, and where the side is polymer reinforced with a higher weight percentage of a polymer than the body, thereby providing increased rigidity to the side. The principles and operations for such methods and systems, according to the present invention, may be better understood with reference to the accompanying description and drawings.

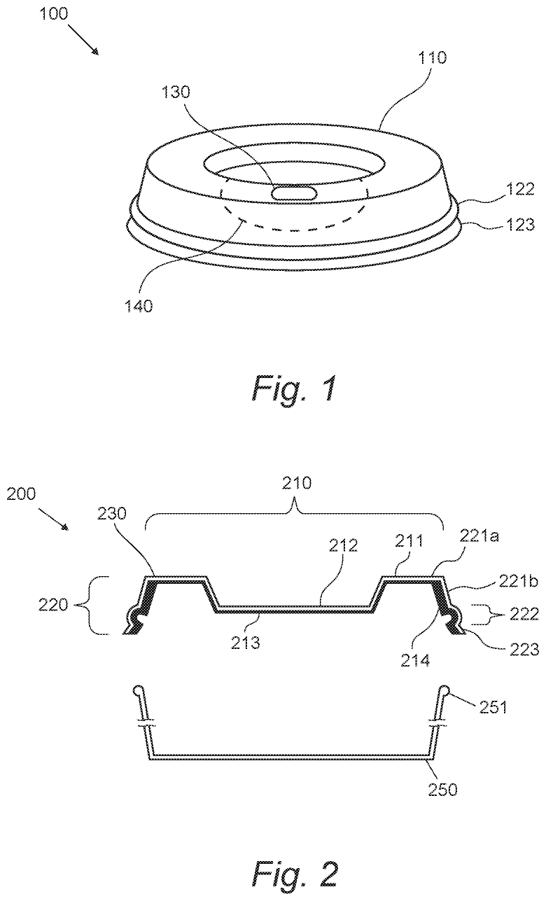

FIG. 1 generally depicts a fiber-containing lid 100 generally comprising a body 110 and a side 122 that depends from the body 110. Side 122 flares outwardly at 123. The lid 100 comprises at least two materials, a fibrous material and a polymer coating.

All suitable fibrous materials are contemplated, including wood and vegetable fibers (as for example utilized in papers and cardboards). Biodegradable paper is especially preferred to reduce negative environmental impact when the lids are disposed.

All suitable polymer materials are contemplated, especially including polymers typically used to coat inside surfaces of paper coffee cups. This includes polyethylene, polypropylene, polyethylene terephthalate, high-density polyethylene, polyvinyl chloride, low-density polyethylene, ultra-high-molecular-weight polyethylene, and any combination thereof.

To reduce the environmental impact, preferred embodiments of the entirely of the lid 100 have no more than 10 wt % the total polymer material(s), more preferably no more than 10 wt % or even 5 wt % polymer, and most preferrably no more than 1 wt % polymer.

The body 110 has a drinking hole 130. It is contemplated that a polymer coating can be disposed on an upper surface of the lid, about at least a region 140 adjacent the drinking hole 130. A coating in that region is thought to provide an improved mouth feel relative to embodiments where the region is not coated, or otherwise provide water resistance or proofing, or thermal insulation. In some embodiments, the polymer coating of the body extends at least 5 mm around the drinking hole 130. To aid with disposal, the polymer coating about drinking hole 130 is peel-able or removable in some embodiments so that the paper or fibrous content of lid 100 can be composted or recycled separately. However, in some embodiments the polymer is bound to the upper surface of the lid, and cannot be peeled off or removed.

In FIG. 2, lid 200 generally has a body 201 and a side 220. The lid 200 is configured to be removably coupled with a cup 250, allowing repeated closing and opening the lid.

Lid 200 includes one or more fibrous materials 221a, 221b extending along both the body 210 and the mating portion, respectively. Fibrous materials 221a and 221b could be the same or different from each other.

In this embodiment, the body 210 has a raised portion 211 that surrounds a depressed portion 212. The raised portion 211 can be of constant height, or of varying heights. Typically, a drinking hole 230 is positioned in the raised portion 211.

Body 210 has a polymer coating 213 on its entire underside, although it is contemplated that there might be embodiments in which there is no overall underside coating. Polymer coating 213 might or might not extend to the medial surface of the side 220. Instead of, or in addition to any polymer coating 213 on its medial surface, side 220 has a thickened coating or layer of polymer 214. Polymers 213, 214 might or might not comprise the same chemical compositions. To aid with disposal, polymer coating 213 or 214 is peel-able or removable in some embodiments so that the paper or fibrous content of lid 200 can be composted or recycled separately. However, in some embodiments polymer coating 213 or 214 is bound to the underside of the lid, and cannot be peeled off or removed.

Side 220 extends circumferentially and downwardly from the body 210. Side 220 is substantially planar. A mating region 222 includes a negative depression in the substantially planar interior surface of side 220 is sized and dimensioned to securely mate with the upper rim bead 251 of the cup 250. For a typical paper coffee cup, the negative depression is preferably an indentation, groove, or channel with a depth of at least 1.5 mm. In some embodiments, the indentation, groove, or channel is continuous about the circumference of the rim, but alternatively can be intermittent. Having a secure seal is desirable because it protects the user from spilling hot liquid such as coffee, tea, or soup over himself or herself.

Side 220 has a flared region 223, sized and dimensioned to assist a user in positioning the lid onto the top upper rim bead of a cup, thereby helping to prevent significant deformation of the lid 200.

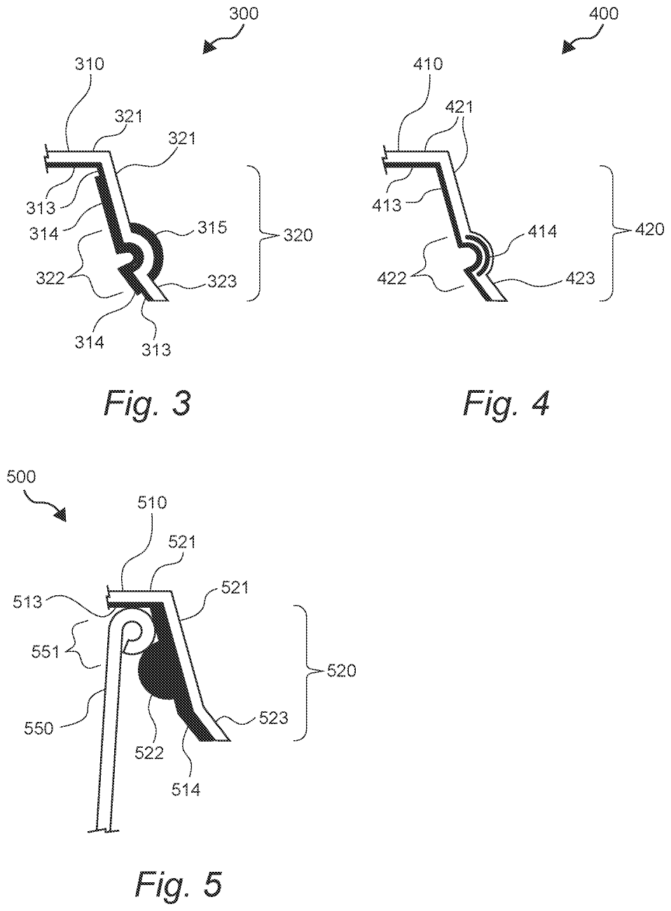

In FIG. 3, an alternative lid 300 has a body 310 and a side 320 with a mating region. Lid 300 includes one or more fibrous materials 321 continuously extending along the body 310 and the side 320.

There is a polymer coating 313 that extends along the entirety of the underside of the body 310 and the medial surface of side 320. The mating portion of side 320 includes an indented region 322 and a flared region 323. There is an extra coating of polymer 314 and 315 on the medial and lateral surfaces, respectively, of the mating region of side 320.

Side 320 has a flared region 323, sized and dimensioned to assist a user in positioning the lid onto the top upper rim bead of a cup, thereby helping to prevent significant deformation of the lid 300.

In FIG. 4, an alternative lid 400 has a body 410 and a side 420, with mating region 422. Lid 400 includes one or more fibrous materials 421 continuously extending along the body 410 and the side 420. There is a polymer coating 413 that extends along the entirety of the underside of the body 410 and the medial surface of side 420. There is an additional layer of polymer 414 positioned within the fibrous material(s) 421 about the mating region 422.

Side 420 has a flared region 423, sized and dimensioned to assist a user in positioning the lid onto the top upper rim bead of a cup, thereby helping to prevent significant deformation of the lid 400.

In FIG. 5, an alternative lid 500 has a body 510 and a side 520. A mating bump or ridge 522 of polymer cooperates with region 551 and the upper rim bead of cup 250 to attach the lid to the cup. In some embodiments, mating bump or ridge 522 is continuous about the interior circumference of side 520. However, mating bump or ridge can also be a plurality of intermittent bumps or ridges along the interior circumference of side 520, for example to provide less resistance or easier attachment of lid 500 to containers. Lid 500 includes one or more fibrous materials 521 continuously extending along the body 510 and the side 520. There is a polymer coating 513 that extends along the entirety of the underside of the body 510, and a thickened coating 514 of the same or different polymer on the medial surface of side 520.

Side 520 has a flared region 523, sized and dimensioned to assist a user in positioning the lid onto the top upper rim bead of a cup, thereby helping to prevent significant deformation of the lid 500.

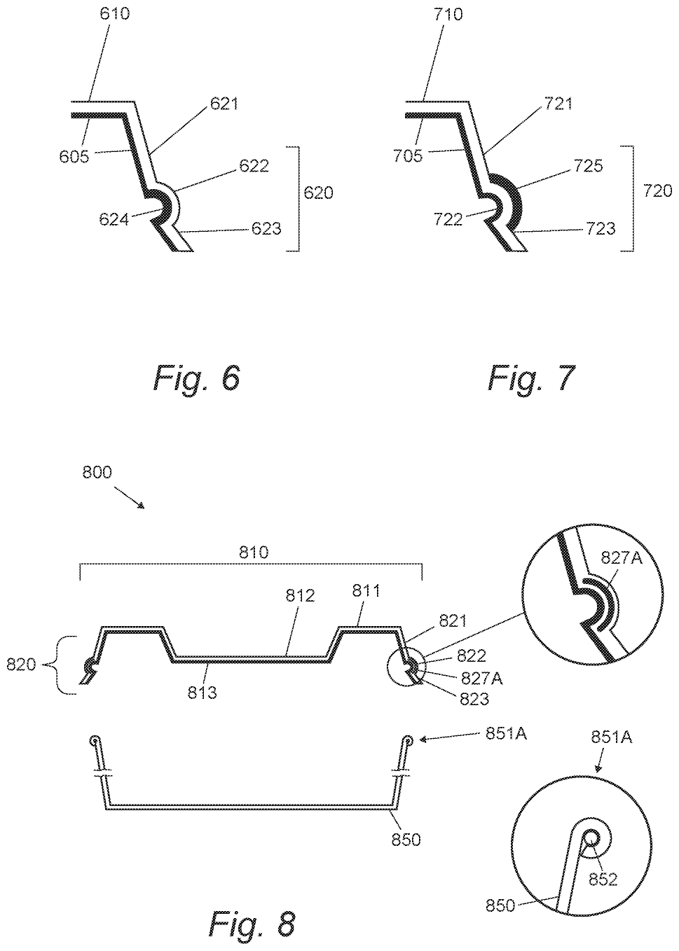

FIG. 6 shows a cross-sectional view of a lid of the inventive subject matter, including body 621 and mating portion 620. There is polymer coating 605 on the underside of the body 621. The mating portion 620 includes an indented region 622 and a flared region 623. There is an extra coating 624 of polymer on part of the medial side of the body 621, and the medial sides of the indented 622 and flared 623 regions.

FIG. 7 shows a cross-sectional view of an alternative lid, including a body 721 and a mating portion 720. There is a polymer coating 705 on the underside of the body 721. The mating portion 720 includes an indented region 722 and a flared region 723. There is an extra coating 725 of polymer on the lateral side of the indented region 722.

It is also contemplated that one could use magnetic coupling so that the cup and lid would “click” together, magnetically, and thereby remain “mated” without the need for any mechanical coupling as in FIGS. 2-7. To that end, in FIG. 8 is similar to FIGS. 2-7, with embedded magnets, metal, or other material attracted by magnetic force, for example upper rim bead 851A is magnetic or includes magnetic material 852, and the stiffening member 827A is a metal or other material attracted by magnetic force.

For example, FIG. 8 shows lid 800 generally has a body 801 and a side 820. The lid 800 is configured to be removably coupled with a cup or container 850, allowing repeated closing and opening of the lid. Lid 800 includes one or more fibrous material 821 extending along both the body 810 and the mating portion. Fibrous materials could be the same or different from each other.

In this embodiment, the body 810 has a raised portion 811 that surrounds a depressed portion 812. The raised portion 811 can be of constant height, or of varying heights. Typically, a drinking hole 830 is positioned in the raised portion 811. Body 810 has a polymer coating 813 on its entire underside, although it is contemplated that there might be embodiments in which there is no overall underside coating. Polymer coating 813 might or might not extend to the medial surface of the side 820. Instead of, or in addition to any polymer coating 813 on its medial surface, side 820 has a thickened coating or layer of polymer.

Side 820 extends circumferentially and downwardly from the body 810. A mating region 822 is sized and dimensioned to securely mate with the upper rim bead 851A of the cup 850. For a typical paper coffee cup, the mating portion would preferably have an indentation with a depth of at least 1.5 mm. Having a secure seal is desirable because it protects the user from spilling of hot liquid such as coffee, tea, and soup over himself or herself.

Side 820 has a flared region 823, sized and dimensioned to assist a user in positioning the lid onto the top upper rim bead of a cup, thereby helping to prevent significant deformation of the lid 800.

In should be understood all of the various embodiments show in the figures herein should be interpreted such that the additional coating or layer of polymer at the mating portion is preferably at least 0.1 mm, more preferably at least 0.2 mm, and most preferably at least 0.3 mm in thickness, and the polymer on the bottom surface of the body covers the entirety of that surface. Also, all of the embodiments depicted herein should be interpreted such that the one or more fibrous materials in the body of the lid can be the same as, or different from, the one or more fibrous materials in the side. Also, all of the embodiments depicted herein should be interpreted as having a drinking hole similar to hole 130 in FIG. 1. Still further, all of the embodiments depicted herein should be interpreted as having at least 20 wt % of fibrous material in their respective sides, more preferably at least 40 wt % of fibrous material in their respective sides, and even more preferably at least 60 wt % of fibrous material in their respective sides.

There are at least two reasons for adding the polymer material to the mating portions of the various embodiments. First, if the polymer is disposed on a medial side of the mating portion, the polymer can protect the mating portion from deformation caused by the liquid or a vapor evaporating from the liquid. Second, including a polymer in the mating portion can significantly enhance stiffness of the mating portion, thereby providing a secure seal with a cup or other vessel.

It is also contemplated that the mating portion could be entirely polymeric, i.e., with no fibrous content. In such instances the polymeric mating portion could have a thin extension that extends up into the body of the lid, or is glued or otherwise adhered to a medial or lateral side of the body.

FIG. 9 depicts the ventral side of lid 900 of the inventive subject matter. Lid 900 is comprised of paper or fibrous material and includes radial edge 902, polymer coated surface 904 extending from radial edge 902 to border 906, and exposed surface 908. In most embodiments, the polymer coating of 904 is coextensive with a polymer layer on the interior surface of the sides of the lid, not pictured from this angle (e.g., see side 220 of FIG. 2). Drinking hole 910 is disposed proximal to radial edge 902 and bounded by polymer coated surface 904 Polymer coated surface 904 is a portion of the ventral surface of lid 900 that is coated with a protective polymer, adding structural integrity to lid 900 at the coated surface, as well as water resistance or proofing, heat resistance, or thermal insulation. Exposed surface 908 is simply the exposed paper or fibrous material lid 900 is comprised of.

In preferred embodiments, border 906 includes perforations to provide easy detachment of exposed surface 908 from polymer coated surface 904. Such a feature is useful for disposing of the lid. The user can separate the paper or fibrous portion of lid 900 for composting, biodegrading, or recycling. The polymer coated portion of lid 900 is then disposed of separately as regular trash, recycled, biodegraded, or composted as appropriate based on the composition of the polymer (e.g., recyclable polymer, biodegradable, compostable, etc.).

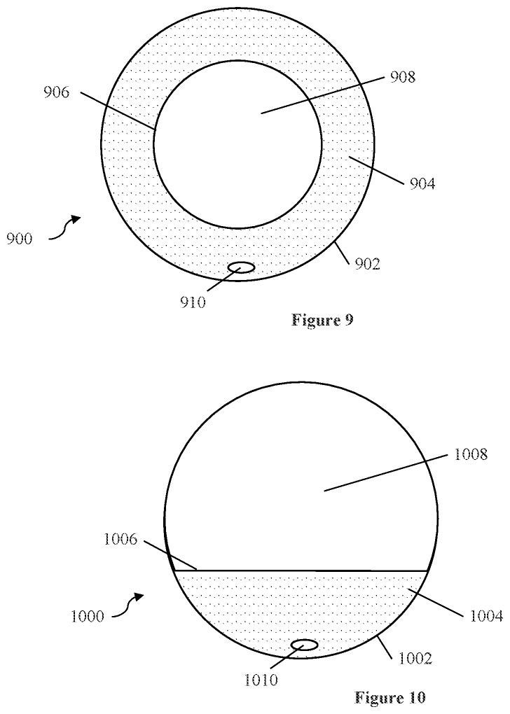

FIG. 10 depicts the ventral side of lid 1000 of the inventive subject matter. Lid 1000 is comprised of paper or fibrous material and includes radial edge 1002, polymer coated surface 1004 extending from radial edge 1002 proximal to drinking hole 1010 to border 1006, and exposed surface 1008. In most embodiments, the polymer coating of 1004 is coextensive with a polymer layer on the interior surface of the sides of the lid, not pictured from this angle (e.g., see side 220 of FIG. 2). Drinking hole 1010 is bounded by polymer coated surface 1004 Polymer coated surface 1004 is a portion of the ventral surface of lid 1000 that is coated with a protective polymer, adding structural integrity to lid 1000 at the coated surface, as well as water resistance or proofing, heat resistance, or thermal insulation. Exposed surface 1008 is simply the exposed paper or fibrous material lid 1000 is comprised of.

In preferred embodiments, border 1006 includes perforations to provide easy detachment of exposed surface 1008 from polymer coated surface 1004. Such a feature is useful for disposing of the lid. The user can separate the paper or fibrous portion of lid 1000 for composting, biodegrading, or recycling. The polymer coated portion of lid 1000 is then disposed of separately as regular trash, recycled, biodegraded, or composted as appropriate based on the composition of the polymer (e.g., recyclable polymer, biodegradable, compostable, etc.).

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A lid for a container having an upper rim bead, the lid comprising: a fiber-containing body; and a mating portion depending from the body, and configured to mate with the upper rim bead; wherein the mating portion has a higher weight percentage of a first polymer than the body.

1. A lid for a container having an upper rim bead, the lid comprising:
a fiber-containing body; and
a fiber-containing mating portion depending from the body, and defining a recess configured to mate with the upper rim bead;
wherein the mating portion and/or the recess has a higher weight percentage of a first polymer than the body.

2. The lid of claim 1, wherein the mating portion comprises a first layer of the first polymer.

3. The lid of claim 2, wherein the mating portion comprises a medial layer of the first polymer.

4. The lid of claim 2 or claim 3, wherein the mating portion comprises a layer of the first polymer disposed within, or on a lateral side thereof.

5. The lid of any one of claims 2 to 4, wherein the mating portion has a layer of the first polymer at least 0.1 mm thick.

6. The lid of claim 5, wherein the mating portion has a layer of the first polymer at least 0.3 mm thick.

7. The lid of any of claims 2 to 6, wherein the body has a first layer of the first polymer.

8. The lid of claim 7, wherein the first layer of the first polymer of the mating portion is thicker than the first layer of the first polymer of the body.

9. The lid of any one of claims 2 to 8, wherein the mating portion has a second layer of the first polymer.

10. The lid of any one of claims 2 to 8, wherein the mating portion has a second layer of a second polymer that has a different chemical composition than the first layer.

11. The lid of any preceding claims, wherein the body comprising a drinking hole, and a layer of a polymer disposed about the drinking hole.

12. The lid of claim 11, wherein the layer of the polymer extends at least 5 mm away from the drinking hole.

13. The lid of claim 11 or claim 12, wherein the body has a raised portion disposed about a central depression, and the drinking hole is disposed in the raised portion.

14. The lid of any of any preceding claim, wherein the fiber-containing lid has no more than 10 wt % of the first polymer.

15. The lid of claim 14, wherein the fiber-containing lid has no more than 5 wt % of the first polymer.

16. The lid of any of claim 15, wherein the fiber-containing lid has no more than 1 wt % of the first polymer.

17. The lid of any preceding claim, wherein the mating portion flares outwardly to a bottom of the lid.

18. The lid of any preceding claim, wherein the recess comprises an annular indentation having a depth of at least 1.5 mm.

19. The lid of any preceding claim, wherein the first polymer comprises polyethylene.
